(19) United States
(12) Patent Application Publication
(10) Pub. No.: US 2016/0285842 A1
(43) Pub. Date: Sep. 29, 2016

(54) CURATOR-FACILITATED MESSAGE GENERATION AND PRESENTATION EXPERIENCES FOR PERSONAL COMPUTING DEVICES

(71) Applicants: CORY J. BOOTH, Beaverton, OR (US); Glen J. Anderson, Beaverton, OR (US); John C. Weast, Portland, OR (US); Lenitra M. Durham, Beaverton, OR (US); Giuseppe Raffa, Portland, OR (US); Deepak S. Vembar, Portland, OR (US)

(72) Inventors: CORY J. BOOTH, Beaverton, OR (US); Glen J. Anderson, Beaverton, OR (US); John C. Weast, Portland, OR (US); Lenitra M. Durham, Beaverton, OR (US); Giuseppe Raffa, Portland, OR (US); Deepak S. Vembar, Portland, OR (US)

(21) Appl. No.: 14/668,608

(22) Filed: Mar. 25, 2015

(51) Int. Cl. H04L 29/06; H04L 29/08

(52) U.S. Cl. CPC H04L 63/08; H04L 63/12; H04L 67/18

(57) ABSTRACT

A mechanism is described for dynamically facilitating curator-controlled message delivery experiences at computing devices according to one embodiment. A method of embodiments, as described herein, includes detecting a computing device at a location, and determining proximity of the computing device from one or more computing devices at or around the location, where the location may relate to an event. The method may further include creating a proximity map including plotting of the computing device and the one or more computing devices, and generating a message for the computing device based on one or more of the proximity map, and communicating the message to at least one of the computing device and the one or more computing devices for presentation.

### FIELD

Embodiments described herein generally relate to computers. More particularly, embodiments relate to dynamically facilitating curator-controlled message generation and presentation experiences for personal computing devices.

### BACKGROUND

With the growth in the use of personal computing devices (e.g., smartphones, tablet computers, wearable devices, etc.), various communication techniques have been employed. However, conventional techniques provide for restricted user experiences as they are severely limited with regard to actively and precisely controlling locations, events, modalities, curators, third-parties, etc.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a dynamic curator-facilitated personal device-based experiences mechanism according to one embodiment.

FIG. 2 illustrates a dynamic curator-facilitated personal device-based experiences mechanism according to one embodiment.

FIG. 3A illustrates a curator-facilitated message generation and presentation experience according to one embodiment.

FIG. 3B illustrates scenes showing the use of personal devices by an event curator via a dynamic curator-facilitated personal device-based experiences mechanism of FIG. 2 according to one embodiment.

FIG. 3C illustrates scenes at a sporting event showing the use of personal devices for message presentation as facilitated by an event curator via a dynamic curator-facilitated personal device-based experiences mechanism of FIG. 2 according to one embodiment.

FIG. 3D illustrates a proximity map including plotting of locations of multiple personal devices according to one embodiment.

FIG. 4 illustrates computer system suitable for implementing embodiments of the present disclosure according to one embodiment.

FIG. 5 illustrates computer environment suitable for implementing embodiments of the present disclosure according to one embodiment.

FIG. 6A illustrates a transaction sequence for facilitating dynamic curator-facilitated message generation and presentation experiences at personal devices according to one embodiment.

FIG. 6B illustrates a method for facilitating dynamic curator-facilitated message generation and presentation experiences at personal devices according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for user-initiated, remotely-controlled, customization of user experiences via personal computing devices. It is to be noted that various computing devices, such as smartphones, tablet computers, wearable devices (e.g., head-mounted displays, wearable glasses, watches, wrist bands, clothing items, jewelry, etc.), and/or the like, may be collectively referred to as “personal computing devices”, “personal computers”, “personal devices”, or simply “devices” throughout this document. It is to be noted that “event curator” and “curator” may be referenced interchangeably throughout this document and that a curator may perform their tasks independently or upon being hired by a third-party or an owner of a location and/or an event, etc., to coordinate an event on their behalf, and/or the like.

Embodiments allow for users of personal devices the ability to specify their willingness to give control over their personal devices to event curators and similarly, allow the event curators to have the ability to invoke multiple actions on the users' personal devices, once the access is allowed. In one embodiment, an event curator may be allowed a complete control of a user's personal device and experiences that are then offered, altered, paused, etc., based on a given location, event, user preference, etc.

Embodiments allow for event curators to have the ability to control and customize, via a curator-facilitated mechanism, the experiences of users (or subsets of users) using their corresponding personal devices in a given location after the users have allowed the curators to have the access the control of their personal devices. For example, in one embodiment, an event curator may employ this technique for any number and type of events and purposes, such as entertainment events (e.g., theme parks, sporting events, etc.), work places, emergencies (e.g., flood warning, fire alert, etc.), etc.

Further, in one embodiment, such experiences may be performed in various modalities, such as visual, auditory, haptic, olfactory, etc., and the personal devices may range from smartphones, tablet computers, wrist or head or other body wearable devices, such as smart glasses, smartwatches, smart bracelets, smart clothing items, etc., to form personal and/or public displays. For example, for a visual display, after opting-in of a group of users, a curator may create a mass display across various personal devices associated with the group of users using proximity sensing and mapping to determine the exact locations of the personal devices, such as in a crowd, to collectively present (such as display, play, transmit, etc.) colored cards, signs, words, sounds, etc., across a stadium, etc.

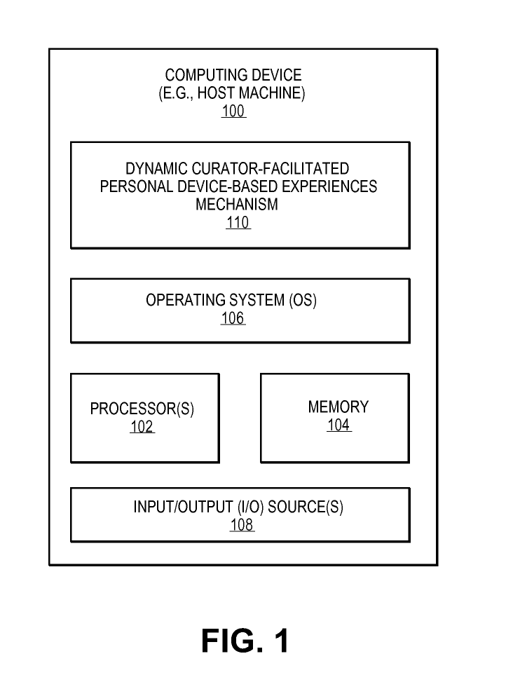

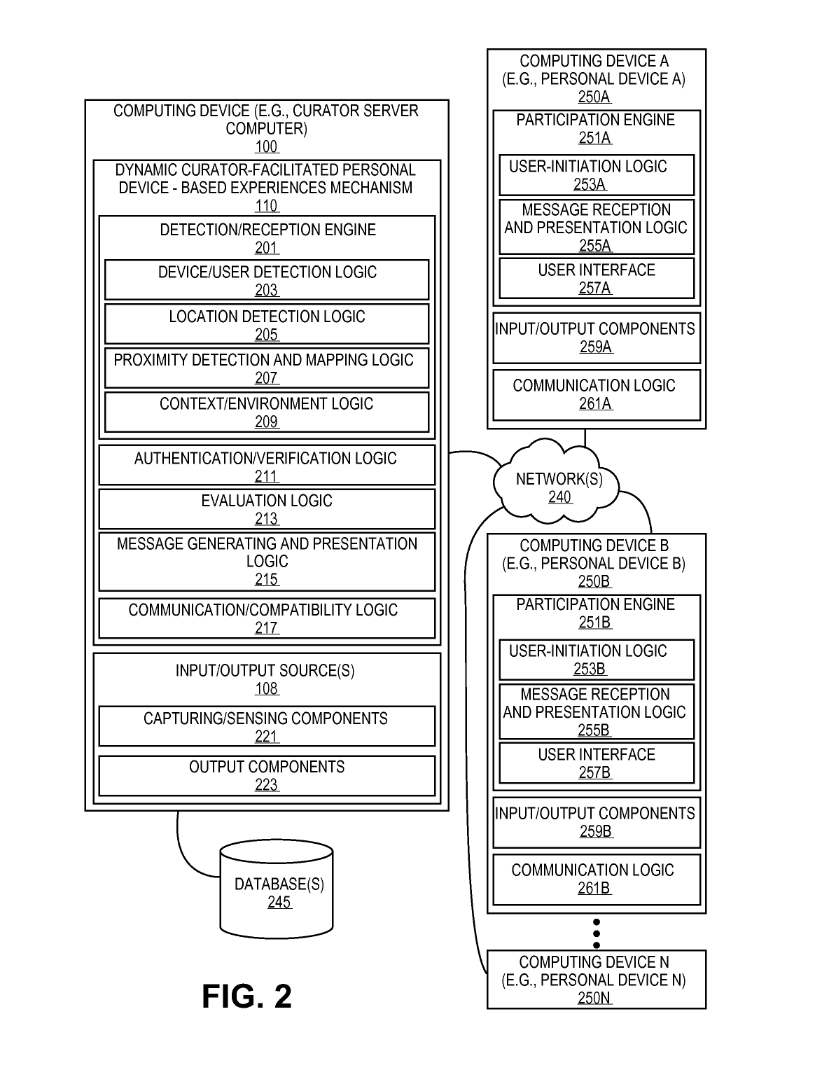

FIG. 1 illustrates a computing device 100 employing a dynamic curator-facilitated personal device-based experiences mechanism 110 according to one embodiment. Computing device 100 serves as a host machine for hosting dynamic curator-facilitated personal device-based experiences mechanism (“curator-facilitated mechanism”) 110 that includes any number and type of components, as illustrated in FIG. 2, to efficiently employ one or more components to dynamically facilitate user-initiated and curator-controlled real-time message generation and presentation experiences on personal devices as will be further described throughout this document.

Computing device 100 may include any number and type of data processing devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers (e.g., Ultrabook™ system, etc.), e-readers, media internes devices (MIDs), media players, smart televisions, television platforms, intelligent devices, computing dust, media players, head-mounted displays (HMDs) (e.g., wearable glasses, such as Google® Glass™, head-mounted binoculars, gaming displays, military headwear, etc.), and other wearable devices (e.g., smartwatches, bracelets, smartcards, jewelry, clothing items, etc.), and/or the like.

As aforementioned, for brevity, clarity, and ease of understanding, throughout this document, “personal device” may collectively refer to any type of mobile computers, wearable devices, smart devices, HMDs, etc.; however, it is contemplated that embodiments are not limited as such to any particular type or number of computing devices.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a group of individuals using or having access to computing device 100.

FIG. 2 illustrates a dynamic curator-facilitated personal device-based experiences mechanism 110 according to one embodiment. In one embodiment, virtual mechanism 110 may include any number and type of components, such as (without limitation): detection/reception engine 201 including device/user detection logic 203, location detection logic 205, proximity detection and mapping logic 207, and context/environment logic 209; authentication/verification logic 211; evaluation logic 213; message generation and presentation logic 215; and communication/compatibility logic 217. Computing device 100 further includes I/O sources 108 having any number and type of capturing/sensing components 221, output components 223, etc.

Computing device 100 may include a server computer controlled, managed, and/or serviced by event curator, where computing device 100 serves as a host machine and be in communication with one or more repositories or databases, such as database(s) 245, where any amount and type of data (e.g., real-time data, historical contents, metadata, resources, policies, criteria, rules and regulations, upgrades, etc.) may be stored and maintained. Similarly, computing device 100 may be in communication with any number and type of client computing devices, such as personal devices A 250A, B 250B, N 250N, over one or more networks, such as network(s) 240 (e.g., cloud network, the Internet, intranet, Internet of Things (“IoT”), proximity network, Bluetooth, etc.).

As aforementioned, personal devices 250A-250N may include any number and type of mobile and wearable devices, such as (without limitation) smartphones, tablet computers, wearable glasses, smart clothes, smart jewelry, and/or the like. As illustrated, each personal device, as illustrated with respect to personal devices 250A and 250B, may include (without limitation): participating engine 251A-B including user initiation logic 253A-B, message reception and presentation logic 255A-B, and user interface 257A-B, etc.; input/output components 259A-B, communication logic 261A-B, etc.

It is contemplated that in one embodiment, each personal device 250A-250N may receive a personalized message, such as an alert, a note, a reminder, etc. In another embodiment, a number of personal devices 250A-250N may receive a part of a single message, such as illustrated there, to collectively play a role in displaying that single message. It is further contemplated and in one embodiment, these curator-controlled messages are not merely limited to texts, images, videos, etc., to be displayed and that such messages may also or only include sounds or audio message, etc.

In one embodiment, curator-facilitated mechanism 110 allows for the users of personal devices 250A-250N to specify their willingness for their one or multiple personal devices 250A-250N to be accessed and used by the event curator to mediate their experiences in a given location or at a specific event. It is contemplated that a single user may own one or more personal devices 250A-250N of different types, forms, capacities, etc. For example, a user may own a smartphone, a tablet computer, a smart clothing item, and a smart bracelet, etc., with each being different from the other and may be selectively used at certain occasions and times. For example, the user may carry the smartphone at all times, but not the smart bracelet or the smart clothing item, etc.

As aforementioned, curator-facilitated mechanism 110 provides for a technique that is not limited to downloading an application that is related to only a single form of service or specific to a user or a given event. In one embodiment, a simple message (e.g., video, still image, audio, etc.) may be generated to be presented a personal device, such as personal device 250A, using one or more of its I/O capabilities, such as I/O components 259A including (without limitations) microphones, speakers, display screens, GPS systems, WiFi components, cellular components, software applications, etc. Further, in one embodiment, group experiences may be offered through curator-facilitated mechanism 110 to enable a group of users (as opposed to a single user) of personal devices 250A-250N as selected and crafted by the event curator, such as providing and presenting a single message (e.g., video, audio, etc.) using a group of personal devices 250A-250N.

Further, in one embodiment, an event may be customized by event curator, via curator-facilitated mechanism 110, for each user of personal device 250A-250N given the location of their corresponding personal device, such as personal device 250A, in relation to or in proximity of other personal devices, such as personal devices 250A, 250N, being accessed by other users within the event.

For example and in one embodiment, the user of personal device A 250A may use user interface 257A as supported and facilitated by user initiation logic 253A to opt-in as a participant with curator-facilitated mechanism 110. In another embodiment, the user may do nothing and automatically receive an invitation at personal device 250A from curator-facilitated mechanism 110 to be part of this curator-controlled message experience and permit curator-facilitated mechanism 110 to access personal device 250A.

In one implementation, the user's participation, whether user-initiated or curator-initiated, refers to the opting-in of the user and the corresponding device 250A to allow the event curator to access certain information relating to the user and personal device 250A which may then be used by curator-facilitated mechanism 110 to remotely generate and facilitate various customized and/or personalized messages to be presented at personal device 250A. Such messages may be received at personal device 250A via message reception and presentation logic 255A as facilitated by communication logic 261A. Further, these messages may be displayed via user interface 257A and/or one or more output components of I/O components 259A, such as a display screen, microphone, etc.

Capturing/sensing components 221 may include any number and type of capturing/sensing devices, such as one or more sending and/or capturing devices (e.g., cameras (e.g., three-dimension (3D) cameras, etc.), microphones, vibration components, tactile components, conductance elements, biometric sensors, chemical detectors, signal detectors, wave detectors, force sensors (e.g., accelerometers), illuminators, etc.) that may be used for capturing any amount and type of visual data, such as images (e.g., photos, videos, movies, audio/video streams, etc.), and non-visual data, such as audio streams (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), environmental/weather conditions, maps, etc. It is contemplated that “sensor” and “detector” may be referenced interchangeably throughout this document. It is further contemplated that one or more capturing/sensing components 221 may further include one or more supporting or supplemental devices for capturing and/or sensing of data, such as illuminators (e.g., infrared (IR) illuminator), light fixtures, generators, sound blockers, etc.

It is further contemplated that in one embodiment, capturing/sensing components 221 may further include any number and type of sensing devices or sensors (e.g., linear accelerometer) for sensing or detecting any number and type of contexts (e.g., estimating horizon, linear acceleration, etc., relating to a mobile computing device, etc.). For example, capturing/sensing components 221 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); gravity gradiometers to study and measure variations in gravitation acceleration due to gravity, etc.

For example, capturing/sensing components 221 may further include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.), biometric sensors (such as to detect fingerprints, etc.), calendar maintenance and reading device), etc.; global positioning system (GPS) sensors; resource requestor; and trusted execution environment (TEE) logic. TEE logic may be employed separately or be part of resource requestor and/or an I/O subsystem, etc. Capturing/sensing components 221 may further include voice recognition devices, photo recognition devices, facial and other body recognition components, voice-to-text conversion components, etc.

Computing device 100 may further include one or more output components 223 to remain in communication with one or more capturing/sensing components 221 and one or more components of curator-facilitated mechanism 110 to facilitate displaying of images, playing or visualization of sounds, displaying visualization of fingerprints, presenting visualization of touch, smell, and/or other sense-related experiences, etc. For example and in one embodiment, output components 223 may include (without limitation) one or more of light sources, display devices and/or screens (e.g., two-dimension (2D) displays, 3D displays, etc.), audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, etc.

In the illustrated embodiment, computing device 100 is shown as hosting curator-facilitated mechanism 110; however, it is contemplated that embodiments are not limited as such and that in another embodiment, curator-facilitated mechanism 110 may be entirely or partially hosted by multiple or a combination of computing devices, such as computing devices 100, 250A-250N; however, throughout this document, for the sake of brevity, clarity, and ease of understanding, curator-facilitated mechanism 100 is shown as being hosted by computing device 100.

In the illustrated embodiment, personal devices 250A-250N include wearable devices include one or more software applications (e.g., device applications, hardware components applications, business/social application, websites, etc.) in communication with curator-facilitated mechanism 110, where a software application may offer one or more user interfaces (e.g., web user interface (WUI), graphical user interface (GUI), touchscreen, etc.) to work with and/or facilitate one or more operations or functionalities of curator-facilitated mechanism 110, such as displaying one or more images, videos, etc., playing one or more sounds, etc., via one or more input/output sources 108.

In one embodiment, personal devices 250A-250N may include one or more of smartphones and tablet computers that their corresponding users may carry in their hands. In another embodiment, personal devices 250A-250N may include wearable devices, such as one or more of wearable glasses, binoculars, watches, bracelets, etc., that their corresponding users may hold in their hands or wear on their bodies, etc. In yet another embodiment, personal devices 250A-250N may include other forms of wearable devices, such as one or more of clothing items, flexible wraparound wearable devices, etc., that may be of any shape or form that their corresponding users may be able to wear on their various body parts, such as knees, arms, wrists, hands, etc.

Referring back to computing device 100, as illustrated, it is shown as hosting curator-facilitated mechanism 110 having detection/reception engine 201 to perform various tasks relating to detection and reception of devices, users, videos, audio, information, contexts, etc. In one embodiment, device/user detection logic 203 may be used to detect one or more devices, such as personal devices A 250A, B 250B, N 250N, over one or more networks, such as network 240 (e.g., proximity network, Internet, Cloud network, etc.). Further, for example, device/user detection logic 203 may be used to receive a participation request from a user of a device, such as personal device A 250A, to participate in curator-controlled user experiences provided through curator-facilitated mechanism 110. Similarly, device/user logic 203 may also be used to receive a user profile from the user upon opting-in, detect updates to user profiles (e.g., changes to user preferences, etc.) from participating users, etc.

In one embodiment, upon detection of or receiving information regarding one or more personal devices 250A-250N and/or their users, authentication/verification logic 211 may be triggered to authenticate each personal device 250A-250N and each user having access to it before proceeding with any of the tasks performed by curator-facilitated mechanism 110. In one embodiment, authentication and/or verification may be performed once, periodically over a predetermined period of time, and/or upon occurrence of one or more events (e.g., receiving profile updates, etc.), and/or the like.

In one embodiment, detection/reception logic 201 may further include location detection logic 205 to detect locations of personal devices 250A-250N using any number and type of location detection techniques, such as one or more GPS sensors of capturing/sensing components 221. Further, any location-relevant information may be ascertained from network 240 (e.g., proximity network, Cloud network, etc.) and/or network provider, etc., being used by one or more of personal devices 250A-250N.

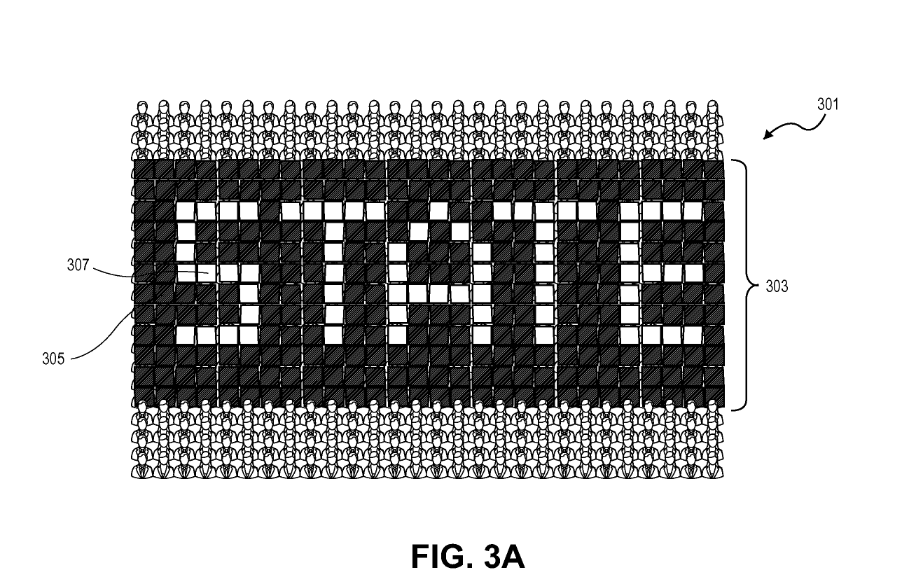

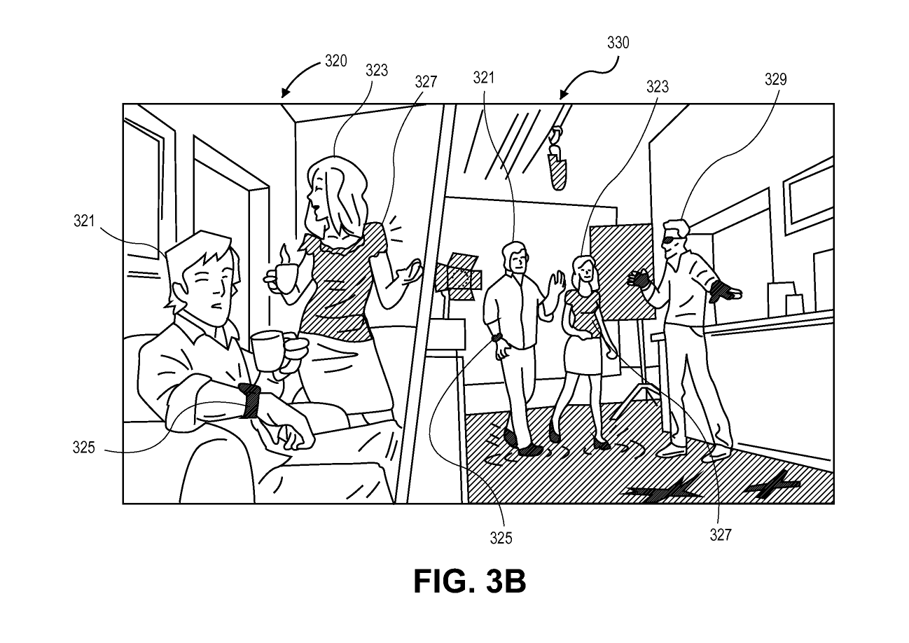

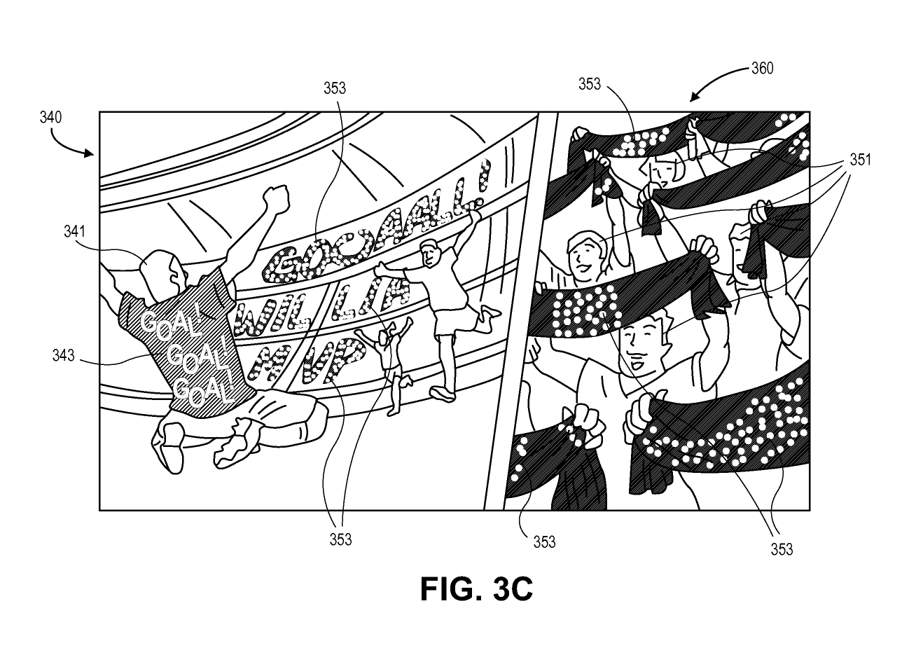

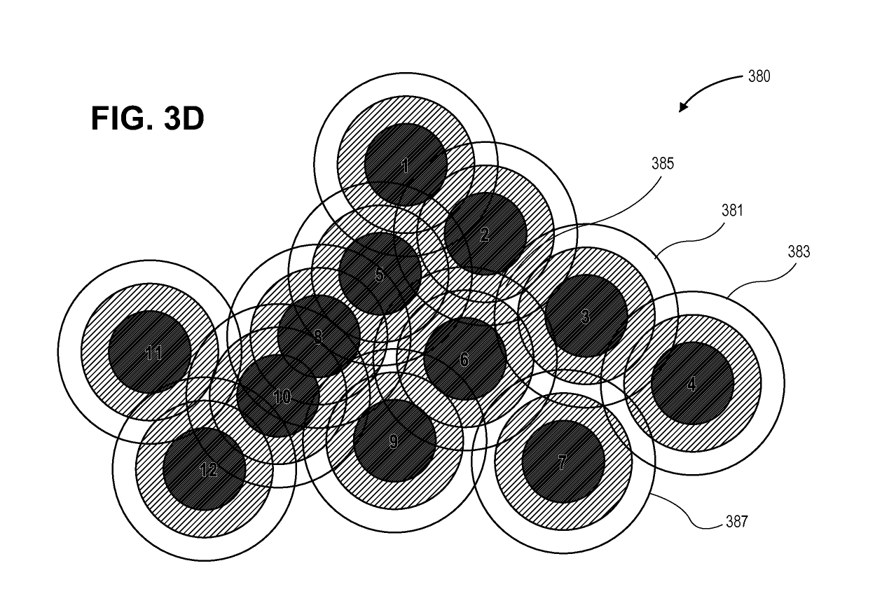

It is contemplated that having detected the locations of personal devices 250A-250N, this information may then be used to determine their proximity to each other using proximity detection and mapping logic 207. For example and in one embodiment, as will be illustrated with respect to FIG. 3D, proximity detection may be used by curator-facilitated mechanism 110 to further enhance the curator-controlled experiences for the users of personal devices 250A-250N. For example, in cases where display resolution can be low, such as when the users are outdoors, a GPS sensor may enable a basic level of proximity coordination, where each personal devices 250A-250N may send its own GPS location to, for example, location detection logic 205 of curator-facilitated mechanism 110 that then allows proximity detection and mapping logic 207 to map the proximity of personal devices 250A-250N with respect to each other and any other point of interests, such as a house, a sporting arena, an event, etc.

In one embodiment, this proximity mapping may then be taken into consideration by evaluation logic 213 to evaluate and determine the type of message that may be generated by message generation logic 215 to be customize for and sent to each personal device 250A-250N as determined and selected by message selection and presentation logic 217.

Moreover, in some embodiments, to allow for additional granularity of proximity, an individual personal device, such as personal device A 250A, may use its own peer-to-peer proximity sensing components (e.g., GPS sensor) to determine the proximity or immediate vicinity of other personal devices, such as personal devices B 250B and/or N 250N, and communicate this information to location detection logic 205 to assist proximity detection and mapping logic 207 to build a proximity map of personal devices 250A-250N. This location/proximity information send by personal devices 250A-250N to curator-facilitated mechanism 110 is then, in turn, used by curator-facilitated mechanism 110 to send an appropriate message to each personal device 250A-250N.

This peer-to-peer proximity sensing may be performed using any number and type of techniques, such as (without limitation) using the Bluetooth signal strength as a parameter available to the operation systems of personal devices 250A-250N and similarly, sound sampling of personal devices 250A-250N as ascertained from sounds detected by various sound sensing components (e.g., microphones) of personal devices 250A-250N which may then be communicated to curator-facilitated mechanism 110 and used by proximity detection and mapping logic 207 to generate a proximity map based on the sound sampling.

Further, for example, simply connecting personal devices 250A-250N to a shared network access point may be sufficient for location detection logic 205 to detect the location of each personal device 250A-250N to determine to their physical proximity to the access point and/or to each other as facilitated by proximity detection and mapping logic 207. Similarly, any number of other techniques, such as detecting retinal implants of a user wearing an HMD, etc., may be used by curator-facilitated mechanism 110 to obtain more specific information about the user (e.g., as permitted by the user in the user profile) for targeting customized and personalized user experiences, such as for communicating personalized advertisements, calendar reminders, notes from and regarding family, emergency information (such as doctor or lawyer contact information), etc.

In one embodiment, context/environment detection logic 209 may be used to detect the context and/or environment associated with personal devices 250A-250N and their users. For example, context/environment detection logic 209 may access, in real-time, various context/environment-related data to determine the current or future status of the user and/or their personal device. For example, by accessing the user's calendar of events, context detection logic 209 may find that the user is in busy with a meeting, playing in a playground, watching a ballgame at a stadium, in-flight or traveling on an airplane, driving a car, attending a family event, etc. Such information may also be determined from accessing the user's preferences as provided in the user profile, reviewing any direct inputs from the user, accessing information from social/business networking websites (e.g., Facebook®, LinkedIn®, etc.) relating to the user, and/or the like. For example, the user of personal device 250A, such as the user of personal device 250A, may use user interface 223 of I/O sources 221 at personal device 250A to input or provide any information relating to the user's status. Further, for example, any amount and type of context information relating to the users and/or personal devices 250A-250N may be stored and maintained at and accessed from one or more databases, such as database 245.

Similarly, in one embodiment, context/environment detection logic 209 may be used to detect and obtain information relating to the environment surrounding the users and/or their personal devices 250A-250N. For example, if the context information (e.g., as obtained from the user's calendar, social network website, etc.) indicates that the user is at a stadium watching a baseball game, context/environment detection logic 209 may detect, for example, the current weather at the stadium, such as by accessing a website, such as weather.com, along with the user's exact location in the stadium using, for example, GPS sensors, Bluetooth, etc. In one embodiment, any information relating to the context and environment may be evaluated by evaluation logic 213 and then forwarded on to message generation logic 215 so that an appropriate decision regarding the potential message may be taken.

Continuing the example of the user being at the baseball stadium, let us suppose the user is associated with two devices, personal device 250A and 250B, where, for example, personal device 250A includes a wearable device, such as t-shirt, and personal device 250B includes a tablet computer. Now, for example, context/environment logic 209 may detect the evening to be very cold and accordingly, the temperature at and around the stadium being very low. In one embodiment, evaluation logic 213 may evaluate the context information (e.g., user is at an open stadium watching a baseball game) and the relevant environment information (e.g., cold evening) to evaluate and conclude that the user is likely to be wearing a jacket over the t-shirt, such as personal device 250A. In another embodiment, device/user detection logic 203 may be used to detect and/or confirm that personal device 250A may not be used to display message because of being covered by a conventional garment, such as the jacket.

In one embodiment, this evaluation that personal device 250A may not be used for displaying message may be further used to determine whether personal device 250B (e.g., tablet computer) may substituted for personal device 250A to display the message or, as an alternative, the message may not be generated or the message-generation process may be aborted all together. For example, if the evaluation recommends that the message be displayed at personal device 250B, message generation and presentation logic 215 may alter the process to generate a message that is appropriate to be presented via personal device 250B. Once the message is generated it may be communicated to personal device 250B via communication/compatibility logic 217 and over network 240. At personal device 250B, like personal device 250A, the message may be received via message reception and presentation logic 255B as facilitated by communication logic 261B and presented via one or more I/O components 259B.

Continuing with the example, if personal device 250N is a participating device and within an acceptable proximity of personal device 250B, in one embodiment, personal device 250N may also receive the same message as the one received by personal device 250B. In another embodiment, as displayed with reference to FIGS. 3A and 3C, a single message may be provided in multiple parts or portions to multiple personal devices such that when the portions are put together, the single message may be collectively displayed and in this case, for example, personal device 250N may receive a portion of the message while personal device 250B receives another part of the same message. It is contemplated that embodiments are not limited to any particular number of personal devices and, for example, hundreds of parts of a single message may be communicated to hundreds of corresponding devices, such as at a ballpark or a concert, etc., which may then be put together to display the message.

It is further contemplated that in case of collective messaging, in some embodiments, not all personal devices 250A-250N may be in coordination or synchronization with each other to be able or willing to participate in a collective presentation of a message. This out-of-sync state and/or lack-of-coordination condition may be encountered due to any number and type of factors, such as (without limitation) device capabilities, implementation details, overriding commitments, any interference causing the coordination/synchronization of the message to be out of sync, and/or the like. For example, in one embodiment, personal devices 250A-N may all be considered and coordinated by the event curator to be part of a larger presentation of a message as facilitated by curator-facilitated mechanism 110; however, for example, personal device 250A may not be able to participate due to one or more of the aforementioned factors as detected by one or more sensors/components of input/output components 259A and as facilitated by message reception and presentation logic 255A. Upon detection that personal device 250A is unable to participate in the collective messaging experience (such as for being out of sync/phase with its surroundings), communication logic 261A of personal device 250A may report this state or condition back to the event curator via curator-facilitated mechanism 110 over network 240. Upon receiving this report at detection/reception engine 201, curator-facilitated mechanism 110 may accordingly correct or adjust its coordination of personal devices 250A, 250B, 250N for better delivery of a synchronized experience on the remaining participating personal devices 250B-250N (removing personal device 250A from the adjusted coordination).

In one embodiment, each personal device 250A-250N may receive a separate message that may include an individually-personalized message. In another embodiment, each of the multiple personal devices 250A-250N may receive a part or section of a single grand message such that multiple personal device 250A-250N may have a group experience by putting together the presentation of their own section of the message to collectively display the grand message. Whether the experience is individual or collective, these messages may be controlled, facilitated, and provided by an event curator using curator-facilitated mechanism 110.

Communication/compatibility logic 217 may be used to facilitate dynamic communication and compatibility between computing device 100 and personal devices 250-250N and any number and type of other computing devices (such as wearable computing devices, mobile computing devices, desktop computers, server computing devices, etc.), processing devices (e.g., central processing unit (CPU), graphics processing unit (GPU), etc.), capturing/sensing components 221 (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) 245 (such as data storage devices, hard drives, solid-state drives, hard disks, memory cards or devices, memory circuits, etc.), network(s) 240 (e.g., Cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and the like, may be referenced interchangeably and include, by way of example, software, hardware, and/or any combination of software and hardware, such as firmware. Further, any use of a particular brand, word, term, phrase, name, and/or acronym, such as “personal device”, “smart device”, “mobile computer”, “wearable device”, “Head-Mounted Display” or “HMD”, “event curator” or “curator”, “message”, “proximity”, “customized experience”, “personalized experience”, etc., should not be read to limit embodiments to software or devices that carry that label in products or in literature external to this document.

It is contemplated that any number and type of components may be added to and/or removed from curator-facilitated mechanism 110 to facilitate various embodiments including adding, removing, and/or enhancing certain features. For brevity, clarity, and ease of understanding of curator-facilitated mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3A illustrates a curator-facilitated message generation and presentation experience according to one embodiment. The illustrated embodiment provides a crowd 301, such as at a sporting event, where the crowd includes any number of users having any number and type of personal devices 305, 307, such as similar to or the same as personal devices 250A-250N of FIG. 2, being used to convey a collective message, such as “STATE”. For example, as illustrated, personal devices 305 are shown as displaying a darker message to provide the background for the actual message, such as STATE, while other personal devices 307 display a lighted message which when put together illustrates the message STATE. In one embodiment, these multiple messages being displayed by personal devices 305, 307 that form a single collective message, STATE, are remotely controlled, facilitated, and provided by an event curator using curator-facilitated mechanism 110 of FIG. 2.

As aforementioned, in one embodiment, each personal device may receive a personalized message, such as an alert, a note, a reminder, etc. In another embodiment, a number of personal devices may receive a part of a single message, such as illustrated there, to collectively play a role in displaying that single message. It is further contemplated and as previously described with reference to FIG. 2, curator-controlled message are not limited to texts, images, videos, etc., to be displayed and that such messages may also include sounds or audio message, etc.

FIG. 3B illustrates scenes 320, 330 showing the use of personal devices 321, 323 by an event curator 329 via curator-facilitated mechanism 110 of FIG. 2 according to one embodiment. In one embodiment, scene 320 show two users 321, 323 having two different personal devices 325, 327 that are participating devices, such as similar to or the same as personal devices 250A-250N of FIG. 2. For example, as illustrated, user 321 is shown as wearing smartwatch 325, and user 323 is shown as wearing smart shirt 327. In scene 320, users 321, 323, serving as the actors, are shown to be taking a break from their set/stage during a drama shooting and at some point, such as when the break is over, their director 329, serving as the curator, in scene 330 issues a stage call to users/actors 321, 323 to get back to the set. The stage call by director/curator 329 leads to buzzing of personal devices 325, 327 of users/actors 321, 323, such as smartwatch 325 and smart shirt 327 are shown as buzzing in scene 320.

Similarly, in scene 330, other uses of curator-facilitated mechanism 110 of FIG. 2 are employed, where director/curator 329 is shown to be using personal devices 325, 327 to indicate to and communicate with users/actors 321, 323 to get in the right spot when they are found to be in the wrong location. Further, in one embodiment, as users/actors walk towards the correct location on the stage, their personal devices 325, 327 may buzz proportionally less and less as they get closer and closer to the correct location on the stage and finally, stopping to buzz upon reaching the correction location.

FIG. 3C illustrates scenes 340, 360 at a sporting event showing the use of personal devices 343, 353 for message presentation as facilitated by an event curator via curator-facilitated mechanism 110 of FIG. 2 according to one embodiment. As illustrated, scene 340 shows user/player 341 scoring a goal at a soccer game and wearing a participating personal device, such as smart shirt 343, which is lighted with words “GOAL!!” upon user/player 341 scoring the goal. In one embodiment, this lighting of smart shirt 343, with the messages of GOAL!!, may be facilitated by the event curator via curator-facilitated mechanism 110 of FIG. 2.

Similarly, in one embodiment and as illustrated, fans 351 may also be wearing or holding participating devices, such as smart scarfs 353, which may also be lighted to convey a collective message, such as “GOOAALL!!” at the upper deck, etc., as shown in scene 340. It is further illustrated that in one embodiment, as shown in scene 360, the close-up of smart scarfs 353 shows that each smart scarf 353 displays a portion of the entire message and that in having a group experience where all smart scarfs 353 are put together, with respect to the event, timing, and their proximity or locations, a full message is formed as shown in scene 340 by having curator-facilitated mechanism 110 coordinating their displays, speakers, other I/O components, etc., to produce this shared experience at the event.

It is contemplated that embodiments are not limited to merely the examples shown or described above with respect to FIGS. 1-3C and that curator-facilitated mechanism 110 and any participating personal devices 250A-250N may be used in any number and type of ways, such as (without limitation): 1) workers on a worksite may be warned of a dangerous situation, such as an earthquake, via their personal devices; 2) amusement park visitors may, via their participating personal devices, allow the event curator to notify them of any events at or near the park, such as planned park events (e.g., shows, character appearances, parades, rides under repair, targeted emergency alerts for lost children, etc.); 3) entirely new forms of art, such as at a modern art museum where the participating personal devices themselves may become part of the installation under the control or guise of an artist, etc.; 4) enabling a movie theater owner to shut off any cellphones in the theater for the length of a move to ensure the movie is not interrupted; 5) allowing the curator to control, via curator-facilitated mechanism 110 of FIG. 2, personal devices, such as personal devices 353, on behalf of other users, such as a user cheering for the home-team may control the display on team smart jerseys of other users, etc.; and 6) enabling fluctuating and/or changing presentations on smart shirts, smart shoes, etc., of performers at a concert, such as the changes in the intensity of the participating performer's singing may cause proportional changes in displays on the performer's smart shirt, smart shoes, etc., and/or the like.

FIG. 3D illustrates a proximity map 380 including plotting of locations of multiple personal devices according to one embodiment. As previously discussed in reference to FIG. 2, any number of proximity detection techniques (e.g., location detection, shared network access point, sound sampling, etc.) may be employed to determine each personal device's proximity to other personal devices within a particular location and/or at a particular event. In the illustrated, proximity map 380 is shown to involve a number of personal devices (such as each number represents a personal device) that are within a proximate distance of each other.

In one embodiment and as illustrated, proximity map 380 may be generated based on sound sampling obtained from each personal device, such as personal devices 3 381, 4 383, 6, 385, 7 387, to indicate the how proximity sensing across end-user personal devices may allow for this proximity map 380 to be formed at a given location. For example, since personal device 383 is not being sensed by personal device 385 but both personal devices 383, 385 can and are being sensed by personal device 381, proximity detection and mapping logic 270 of FIG. 2 may infer that personal device 381 is at least to some degree between personal device 383 and personal device 385; similarly, personal device 387 may be determined to be at least somewhat in between personal device 383 and personal device 385.

In one embodiment, as additional nodes representing new personal devices are detected by other personal device of proximity map 380 and/or via device/user detection logic 203 of FIG. 2, the new personal devices may then be added and proximity map 380 may be accordingly expanded. Further, in some embodiments, a combination of proximity detection techniques may applied, such as along with sound sampling, infrastructure-based access points may be determined and/or GPS sampling may be obtained to provide a better orientation in proximity map 380.

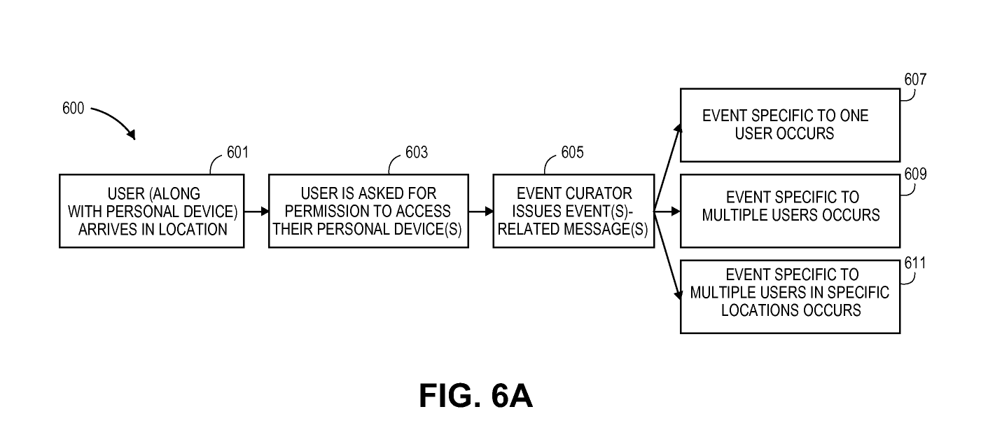

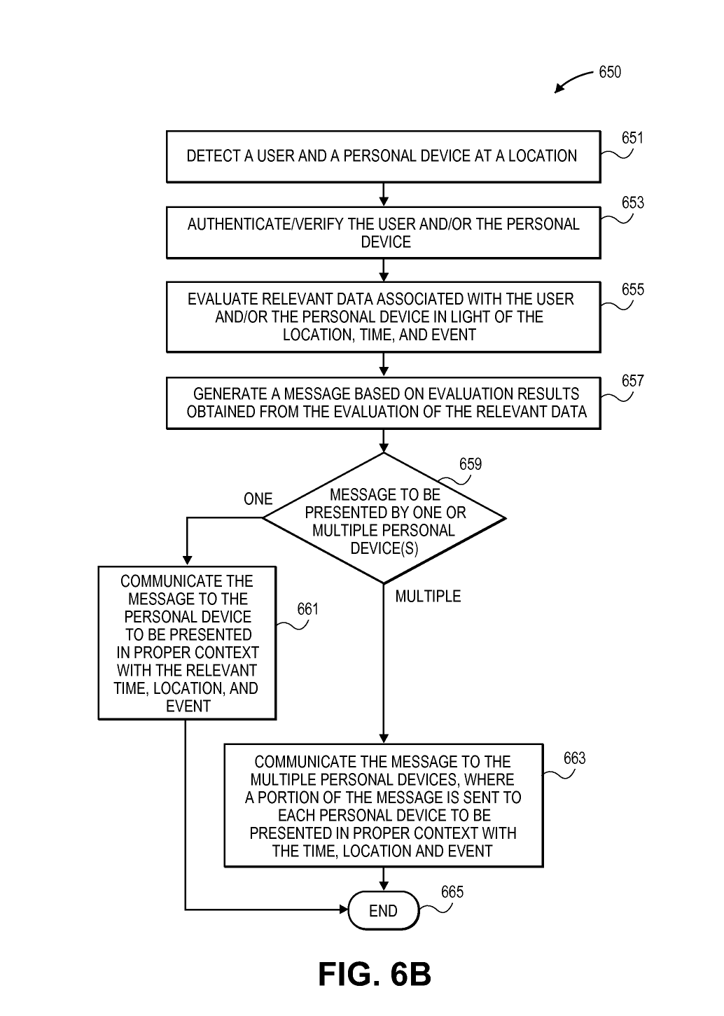

Referring now to FIG. 6A, it illustrates a transaction sequence 600 for facilitating dynamic curator-facilitated message presentation experiences at personal devices according to one embodiment. Transaction sequence 600 may be performed by processing logic that may comprise hardware (e.g., circuitry, dedicated logic, programmable logic, etc.), software (such as instructions run on a processing device), or a combination thereof. In one embodiment, transaction sequence may be performed by curator-facilitated mechanism 110 of FIGS. 1-2. The processes of transaction sequence 600 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

Transaction sequence 600 begins at block 601 with a user along with a personal device arrives at a particular location, such as the location of an event. It is contemplated the one user can have one or multiple personal devices of varying brands, types, forms, sizes, capacities, etc., and that embodiments are not limited as such. It is further contemplated that the user may be one of any number of users and the personal device may be one of any number of personal devices arriving at the same location, such as for the same event. At block 603, in one embodiment, the user, via the personal device, may be asked by an event curator a permission to access the user's personal device. In another embodiment, the user may be the one to opt-in by contacting the curator, such as via the curator's website, etc. At block 605, the curator issues event-related messages to be communicated with and subsequently presented at one or more personal devices.

At block 607, in one embodiment, an event-related message specific to a particular user at the location may be issued to and presented at a particular personal device associated with that user. At block 609, in another embodiment, an event-related message specific to multiple users at the location may be issued to and presented at multiple personal devices associated with the multiple users. At block 611, in yet another embodiment, an event-related message specific to multiple users in multiple locations may be issued to and presented at multiple personal devices associated with the multiple users.

FIG. 6B illustrates a method 650 for facilitating dynamic curator-facilitated message generation and presentation experiences at personal devices according to one embodiment. Method 650 may be performed by processing logic that may comprise hardware (e.g., circuitry, dedicated logic, programmable logic, etc.), software (such as instructions run on a processing device), or a combination thereof. In one embodiment, transaction sequence may be performed by curator-facilitated mechanism 110 of FIGS. 1-2. The processes of method 650 are illustrated in linear sequences for brevity and clarity in presentation; however, it is contemplated that any number of them can be performed in parallel, asynchronously, or in different orders. For brevity, many of the details discussed with reference to the previous figures may not be discussed or repeated hereafter.

Method begins at block 651 with detecting of a user and a personal device associated with the user at a given location. In one embodiment, this detection may be initiated by the user via a user interface at the personal device by contacting an event curator, such as via a website associated with the curator, and, in another embodiment, the detection may be automatically and dynamically performed by the curator using one or more components of curator-facilitated mechanism 110 of FIG. 2 by detecting the user's personal device. For example and as aforementioned with reference to FIG. 2, detection of the user and/or the personal device may include (without limitation) detecting and/or receiving device credentials associated with the personal device, user profile associated with the user, location of the personal device, proximity of the personal device in relation to other personal devices, and context and/or environment associated with the user and/or the personal device.

At block 653, the user and/or the personal device are authenticated and verified to participate in the curator-facilitated message generation and presentation experiences. At block 655, various data relating to the user and/or the personal device are evaluated, where the data may include any of the aforementioned information, such as the location, the proximity, the context, the environment, etc. At block 657, evaluation results are generated based on the evaluation of the relevant data and subsequently, the evaluation results are considered in generation and presentation of a message at the personal device.

At block 659, in one embodiment, a determination is made as to whether the message is to be received at the (one) personal device associated with the (one) user or multiple personal devices associated with multiple users. If the message is to be sent to the single personal device, at block 661, in one embodiment, the message may then be communicated on to the personal device where it is presented (e.g., in various modalities, such as video/pictures/lights message, audio/sounds/noise message, haptic message, olfactory message, etc.) in its proper context with the location, time, event, and/or the like, as previously described with reference to FIG. 2, and the process ends at block 665.

If, however, the message is to be sent to multiple personal devices (including the personal device) associated with multiple users (including the user), at block 663, in one embodiment, the message may then be communicated on to the multiple personal devices where it is presented (e.g., in various modalities, such as video/pictures/lights message, audio/sounds/noise message, haptic message, olfactory message, etc.) in proper context with the relevant location, time, event, and/or the like, as previously described with reference to FIG. 2, and the process ends at block 665.

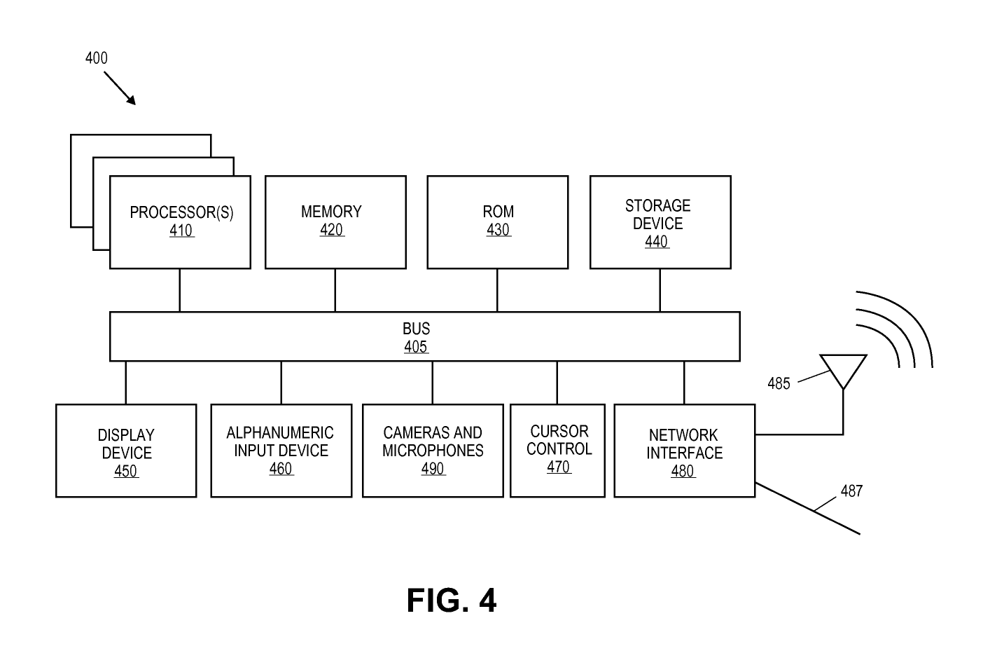

Now referring to FIG. 4, it illustrates an embodiment of a computing system 400 capable of supporting the operations discussed above. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 400 may be the same as or similar to or include computing devices 100 described in reference to FIG. 1.

Computing system 400 includes bus 405 (or, for example, a link, an interconnect, or another type of communication device or interface to communicate information) and processor 410 coupled to bus 405 that may process information. While computing system 400 is illustrated with a single processor, it may include multiple processors and/or co-processors, such as one or more of central processors, image signal processors, graphics processors, and vision processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

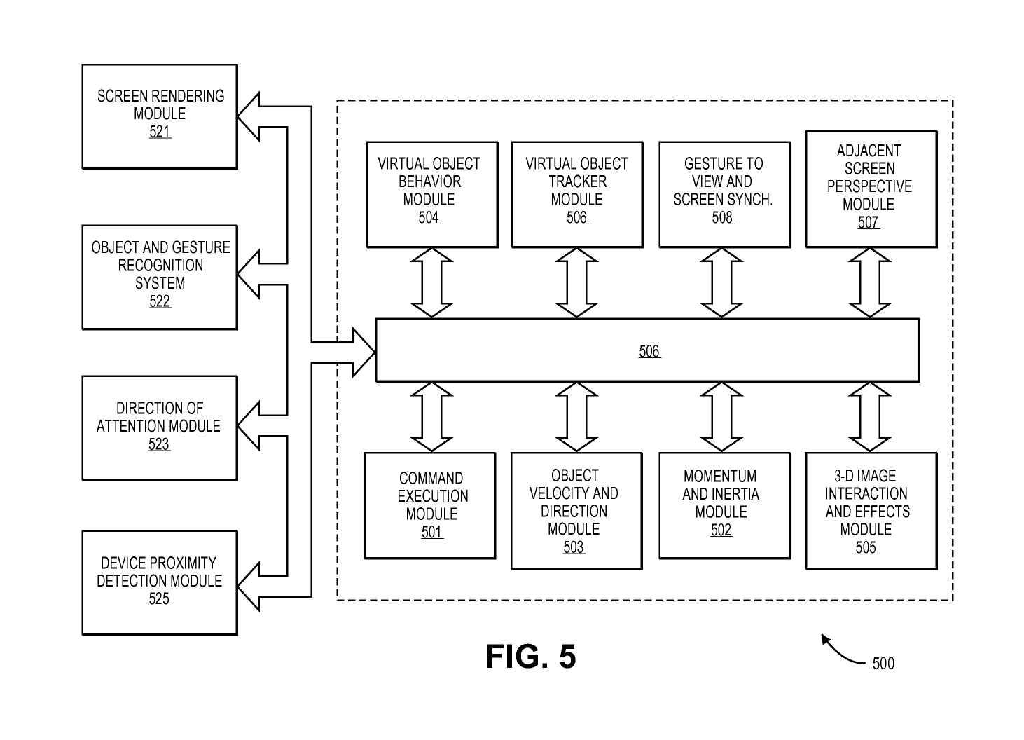

FIG. 5 illustrates an embodiment of a computing environment 500 capable of supporting the operations discussed above. The modules and systems can be implemented in a variety of different hardware architectures and form factors including that shown in FIG. 4.

The Command Execution Module 501 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 521 draws objects on the one or more multiple screens for the user to see. It can be adapted to receive the data from the Virtual Object Behavior Module 504, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 507, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 522 may be adapted to recognize and track hand and harm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without benefit of a touch surface.

The Direction of Attention Module 523 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 522 to ensure that the gestures or commands are associated with the appropriate library for the active display. Similarly, if the user is looking away from all of the screens, then commands can be ignored.

The Device Proximity Detection Module 525 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 522. For a display device, it may be considered by the Adjacent Screen Perspective Module 507.

The Virtual Object Behavior Module 504 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 506 on the other hand may be adapted to track where a virtual object should be located in three dimensional space in a vicinity of an display, and which body part of the user is holding the virtual object, based on input from the Object and Gesture Recognition Module. The Virtual Object Tracker Module 506 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 508, receives the selection of the view and screen or both from the Direction of Attention Module 523 and, in some cases, voice commands to determine which view is the active view and which screen is the active screen. It then causes the relevant gesture library to be loaded for the Object and Gesture Recognition System 522. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 507, which may include or be coupled to the Device Proximity Detection Module 525, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 507 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 503 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 502 can use image motion, image size, and angle changes of objects in the image plane or in a three-dimensional space to estimate the velocity and direction of objects in the space or on a display. The Momentum and Inertia Module is coupled to the Object and Gesture Recognition System 522 to estimate the velocity of gestures performed by hands, fingers, and other body parts and then to apply those estimates to determine momentum and velocities to virtual objects that are to be affected by the gesture.

The 3D Image Interaction and Effects Module 505 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to dynamically facilitate curator-controlled message delivery experiences at computing devices, comprising: device/user detection logic of detection/reception engine to detect a computing device at a location; proximity detection and mapping logic of the detection/reception engine to determine proximity of the computing device from one or more computing devices at or around the location, wherein the location relates to an event, and wherein the proximity detection and mapping logic is further to create a proximity map including plotting of the computing device and the one or more computing devices; and message generation and presentation logic to generate a message for the computing device based on the proximity map, wherein the message generation and presentation logic is further to communicate the message to at least one of the computing device and the one or more computing devices for presentation.

Example 2 includes the subject matter of Example 1, further comprising location detection logic to detect at least one of the location associated with the computing device and one or more locations associated with the one or more computing devices, wherein the location and the one or more locations are plotted in the proximity map via the proximity detection and mapping logic.

Example 3 includes the subject matter of Example 1, further comprising authentication/verification logic to authenticate at least one of the computing device, the one or more computing devices, a user associated with the computing device, and one or more users associated with the one or more computing devices, wherein the authentication/verification logic is further to verify at least one of a participation initiation request from at least one of the user via the computing device and the one or more users via the one or more computing devices.

Example 4 includes the subject matter of Example 1, further comprising context/environment logic to determine, via one or more capturing/sensing components, at least one of context-related information and environment-related data relating to at least one of the user, the computing device, the one or more users, and the one or more computing devices.

Example 5 includes the subject matter of Example 1, further comprising evaluation logic to evaluate one or more of the proximity map, the event, the context-related information, the environment-related data, and time, wherein the time includes a presentation time of the message, wherein the message is further generated based on evaluation results obtained from the evaluation.

Example 6 includes the subject matter of Example 1 or 5, further comprising a database to store the evaluation results and one or more of the proximity map, the event, the time, the context-related information, and the environment-related data.

Example 7 includes the subject matter of Example 1, wherein the message is communicated, via communication/compatibility logic, to the computing device to be presented at the computing device, wherein the message includes one or more of an audio message, a video message, an image message, a olfactory message, and a haptic message.

Example 8 includes the subject matter of Example 1 or 7, wherein a portion of the message is communicated, via the communication/compatibility logic, to the computing device, and wherein one or more portions of the message are communicated, via the communication/compatibility logic, to the one or more computing devices, wherein the portion and the one or more portions, when presented simultaneously at the computing device and the one or more computing devices, form the message.

Example 9 includes the subject matter of Example 1, wherein the computing device and the one or more computing devices comprises mobile computers including one or more of smartphones, tablet computers, laptops, head-mounted displays, head-mounted gaming displays, wearable glasses, wearable binoculars, smart jewelry, smartwatches, smartcards, and smart clothing items.

Example 10 includes the subject matter of Example 1, wherein the message generation and presentation logic to facilitate message reception and presentation logic at the computing device to receive the message and present the message via one or more input/output components, wherein the participation initiation request is initiated via user-initiated logic and placed via a user interface.

Some embodiments pertain to Example 11 that includes a method for dynamically facilitating curator-controlled message delivery experiences at computing devices, comprising: detecting a computing device at a location; determining proximity of the computing device from one or more computing devices at or around the location, wherein the location relates to an event; creating a proximity map including plotting of the computing device and the one or more computing devices; generating a message for the computing device based on one or more of the proximity map; and communicating the message to at least one of the computing device and the one or more computing devices, wherein the message is communicated for presentation.

Example 12 includes the subject matter of Example 11, further comprising detecting at least one of the location associated with the computing device and one or more locations associated with the one or more computing devices, wherein the location and the one or more locations are plotted in the proximity map via the proximity detection and mapping logic.

Example 13 includes the subject matter of Example 11, further comprising: authenticating at least one of the computing device, the one or more computing devices, a user associated with the computing device, and one or more users associated with the one or more computing devices; and verifying at least one of a participation initiation request from at least one of the user via the computing device and the one or more users via the one or more computing devices.

Example 14 includes the subject matter of Example 11, further comprising determining, via one or more capturing/sensing components, at least one of context-related information and environment-related data relating to at least one of the user, the computing device, the one or more users, and the one or more computing devices.

Example 15 includes the subject matter of Example 11, further comprising evaluating one or more of the proximity map, the event, the context-related information, the environment-related data, and time, wherein the time includes a presentation time of the message, wherein the message is further generated based on evaluation results obtained from the evaluation.

Example 16 includes the subject matter of Example 11 or 15, further comprising storing, via a database, the evaluation results and one or more of the proximity map, the event, the time, the context-related information, and the environment-related data.

Example 17 includes the subject matter of Example 11, wherein the message is communicated to the computing device to be presented at the computing device, wherein the message includes one or more of an audio message, a video message, an image message, a olfactory message, and a haptic message.

Example 18 includes the subject matter of Example 11 or 17, wherein a portion of the message is communicated to the computing device, and wherein one or more portions of the message are communicated to the one or more computing devices, wherein the portion and the one or more portions, when presented simultaneously at the computing device and the one or more computing devices, form the message.

Example 19 includes the subject matter of Example 11, wherein the computing device and the one or more computing devices comprises mobile computers including one or more of smartphones, tablet computers, laptops, head-mounted displays, head-mounted gaming displays, wearable glasses, wearable binoculars, smart jewelry, smartwatches, smartcards, and smart clothing items.

Example 20 includes the subject matter of Example 11, further comprising facilitating the computing device to receive the message and present the message via one or more input/output components, wherein the participation initiation request is initiated via user-initiated logic and placed via a user interface.

Example 21 includes at least one machine-readable medium comprising a plurality of instructions, when executed on a computing device, to implement or perform a method or realize an apparatus as claimed in any preceding claims or examples.

Example 22 includes at least one non-transitory or tangible machine-readable medium comprising a plurality of instructions, when executed on a computing device, to implement or perform a method or realize an apparatus as claimed in any preceding claims or examples.

Example 23 includes a system comprising a mechanism to implement or perform a method or realize an apparatus as claimed in any preceding claims or examples.

Example 24 includes an apparatus comprising means to perform a method as claimed in any preceding claims or examples.

Example 25 includes a computing device arranged to implement or perform a method or realize an apparatus as claimed in any preceding claims or examples.

Example 26 includes a communications device arranged to implement or perform a method or realize an apparatus as claimed in any preceding claims or examples.

Some embodiments pertain to Example 27 includes a system comprising a storage device having instructions, and a processor to execute the instructions to facilitate a mechanism to perform one or more operations comprising: detecting a computing device at a location; determining proximity of the computing device from one or more computing devices at or around the location, wherein the location relates to an event; creating a proximity map including plotting of the computing device and the one or more computing devices; generating a message for the computing device based on one or more of the proximity map; and communicating the message to at least one of the computing device and the one or more computing devices, wherein the message is communicated for presentation.

Example 28 includes the subject matter of Example 27, wherein the one or more operations comprise detecting at least one of the location associated with the computing device and one or more locations associated with the one or more computing devices, wherein the location and the one or more locations are plotted in the proximity map via the proximity detection and mapping logic.

Example 29 includes the subject matter of Example 27, wherein the one or more operations comprise: authenticating at least one of the computing device, the one or more computing devices, a user associated with the computing device, and one or more users associated with the one or more computing devices; and verifying at least one of a participation initiation request from at least one of the user via the computing device and the one or more users via the one or more computing devices.

Example 30 includes the subject matter of Example 27, wherein the one or more operations comprise determining, via one or more capturing/sensing components, at least one of context-related information and environment-related data relating to at least one of the user, the computing device, the one or more users, and the one or more computing devices.

Example 31 includes the subject matter of Example 27, wherein the one or more operations comprise evaluating one or more of the proximity map, the event, the context-related information, the environment-related data, and time, wherein the time includes a presentation time of the message, wherein the message is further generated based on evaluation results obtained from the evaluation.

Example 32 includes the subject matter of Example 27 or 31, wherein the one or more operations comprise storing, via a database, the evaluation results and one or more of the proximity map, the event, the time, the context-related information, and the environment-related data.

Example 33 includes the subject matter of Example 27, wherein the message is communicated to the computing device to be presented at the computing device, wherein the message includes one or more of an audio message, a video message, an image message, a olfactory message, and a haptic message.

Example 34 includes the subject matter of Example 27 or 33, wherein a portion of the message is communicated to the computing device, and wherein one or more portions of the message are communicated to the one or more computing devices, wherein the portion and the one or more portions, when presented simultaneously at the computing device and the one or more computing devices, form the message.

Example 35 includes the subject matter of Example 27, wherein the computing device and the one or more computing devices comprises mobile computers including one or more of smartphones, tablet computers, laptops, head-mounted displays, head-mounted gaming displays, wearable glasses, wearable binoculars, smart jewelry, smartwatches, smartcards, and smart clothing items.

Example 36 includes the subject matter of Example 27, wherein the one or more operations comprise facilitating the computing device to receive the message and present the message via one or more input/output components, wherein the participation initiation request is initiated via user-initiated logic and placed via a user interface.

Some embodiments pertain to Example 37 includes an apparatus comprising: means for detecting a computing device at a location; means for determining proximity of the computing device from one or more computing devices at or around the location, wherein the location relates to an event; means for creating a proximity map including plotting of the computing device and the one or more computing devices; means for generating a message for the computing device based on one or more of the proximity map; and means for communicating the message to at least one of the computing device and the one or more computing devices, wherein the message is communicated for presentation.

Example 38 includes the subject matter of Example 37, wherein the one or more operations comprise detecting at least one of the location associated with the computing device and one or more locations associated with the one or more computing devices, wherein the location and the one or more locations are plotted in the proximity map via the proximity detection and mapping logic.

Example 39 includes the subject matter of Example 37, wherein the one or more operations comprise: authenticating at least one of the computing device, the one or more computing devices, a user associated with the computing device, and one or more users associated with the one or more computing devices; and verifying at least one of a participation initiation request from at least one of the user via the computing device and the one or more users via the one or more computing devices.

Example 40 includes the subject matter of Example 37, wherein the one or more operations comprise determining, via one or more capturing/sensing components, at least one of context-related information and environment-related data relating to at least one of the user, the computing device, the one or more users, and the one or more computing devices.

Example 41 includes the subject matter of Example 37, wherein the one or more operations comprise evaluating one or more of the proximity map, the event, the context-related information, the environment-related data, and time, wherein the time includes a presentation time of the message, wherein the message is further generated based on evaluation results obtained from the evaluation.

Example 42 includes the subject matter of Example 37 or 41, wherein the one or more operations comprise storing, via a database, the evaluation results and one or more of the proximity map, the event, the time, the context-related information, and the environment-related data.

Example 43 includes the subject matter of Example 37, wherein the message is communicated to the computing device to be presented at the computing device, wherein the message includes one or more of an audio message, a video message, an image message, a olfactory message, and a haptic message.

Example 44 includes the subject matter of Example 37 or 43, wherein a portion of the message is communicated to the computing device, and wherein one or more portions of the message are communicated to the one or more computing devices, wherein the portion and the one or more portions, when presented simultaneously at the computing device and the one or more computing devices, form the message.

Example 45 includes the subject matter of Example 37, wherein the computing device and the one or more computing devices comprises mobile computers including one or more of smartphones, tablet computers, laptops, head-mounted displays, head-mounted gaming displays, wearable glasses, wearable binoculars, smart jewelry, smartwatches, smartcards, and smart clothing items.

Example 46 includes the subject matter of Example 37, wherein the one or more operations comprise facilitating the computing device to receive the message and present the message via one or more input/output components, wherein the participation initiation request is initiated via user-initiated logic and placed via a user interface.

Example 47 includes at least one non-transitory or tangible machine-readable medium comprising a plurality of instructions, when executed on a computing device, to implement or perform a method as claimed in any of claims or examples 11-20.

Example 48 includes at least one machine-readable medium comprising a plurality of instructions, when executed on a computing device, to implement or perform a method as claimed in any of claims or examples 11-20.

Example 49 includes a system comprising a mechanism to implement or perform a method as claimed in any of claims or examples 11-20.

Example 50 includes an apparatus comprising means for performing a method as claimed in any of claims or examples 11-20.

Example 51 includes a computing device arranged to implement or perform a method as claimed in any of claims or examples 11-20.

Example 52 includes a communications device arranged to implement or perform a method as claimed in any of claims or examples 11-20.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
device/user detection logic of detection/reception engine to detect a computing device at a location;
proximity detection and mapping logic of the detection/reception engine to determine proximity of the computing device from one or more computing devices at or around the location, wherein the location relates to an event, and wherein the proximity detection and mapping logic is further to create a proximity map including plotting of the computing device and the one or more computing devices; and
message generation and presentation logic to generate a message for the computing device based on the proximity map, wherein the message generation and presentation logic is further to communicate the message to at least one of the computing device and the one or more computing devices for presentation.

2. The apparatus of claim 1, further comprising location detection logic to detect at least one of the location associated with the computing device and one or more locations associated with the one or more computing devices, wherein the location and the one or more locations are plotted in the proximity map via the proximity detection and mapping logic.

3. The apparatus of claim 1, further comprising authentication/verification logic to authenticate at least one of the computing device, the one or more computing devices, a user associated with the computing device, and one or more users associated with the one or more computing devices, wherein the authentication/verification logic is further to verify at least one of a participation initiation request from at least one of the user via the computing device and the one or more users via the one or more computing devices.

4. The apparatus of claim 1, further comprising context/environment logic to determine, via one or more capturing/sensing components, at least one of context-related information and environment-related data relating to at least one of the user, the computing device, the one or more users, and the one or more computing devices.

5. The apparatus of claim 1, further comprising evaluation logic to evaluate one or more of the proximity map, the event, the context-related information, the environment-related data, and time, wherein the time includes a presentation time of the message, wherein the message is further generated based on evaluation results obtained from the evaluation.

6. The apparatus of claim 5, further comprising a database to store the evaluation results and one or more of the proximity map, the event, the time, the context-related information, and the environment-related data.

7. The apparatus of claim 1, wherein the message is communicated, via communication/compatibility logic, to the computing device to be presented at the computing device, wherein the message includes one or more of an audio message, a video message, an image message, a olfactory message, and a haptic message.

8. The apparatus of claim 7, wherein a portion of the message is communicated, via the communication/compatibility logic, to the computing device, and wherein one or more portions of the message are communicated, via the communication/compatibility logic, to the one or more computing devices, wherein the portion and the one or more portions, when presented simultaneously at the computing device and the one or more computing devices, form the message.

9. The apparatus of claim 1, wherein the computing device and the one or more computing devices comprises mobile computers including one or more of smartphones, tablet computers, laptops, head-mounted displays, head-mounted gaming displays, wearable glasses, wearable binoculars, smart jewelry, smartwatches, smartcards, and smart clothing items.

10. The apparatus of claim 1, wherein the message generation and presentation logic to facilitate message reception and presentation logic at the computing device to receive the message and present the message via one or more input/output components, wherein the participation initiation request is initiated via user-initiated logic and placed via a user interface.

11. A method comprising:
detecting a computing device at a location;
determining proximity of the computing device from one or more computing devices at or around the location, wherein the location relates to an event;
creating a proximity map including plotting of the computing device and the one or more computing devices;
generating a message for the computing device based on one or more of the proximity map; and
communicating the message to at least one of the computing device and the one or more computing devices, wherein the message is communicated for presentation.

12. The method of claim 11, further comprising detecting at least one of the location associated with the computing device and one or more locations associated with the one or more computing devices, wherein the location and the one or more locations are plotted in the proximity map via the proximity detection and mapping logic.

13. The method of claim 11, further comprising:
authenticating at least one of the computing device, the one or more computing devices, a user associated with the computing device, and one or more users associated with the one or more computing devices; and
verifying at least one of a participation initiation request from at least one of the user via the computing device and the one or more users via the one or more computing devices.

14. The method of claim 11, further comprising determining, via one or more capturing/sensing components, at least one of context-related information and environment-related data relating to at least one of the user, the computing device, the one or more users, and the one or more computing devices.

15. The method of claim 11, further comprising evaluating one or more of the proximity map, the event, the context-related information, the environment-related data, and time, wherein the time includes a presentation time of the message, wherein the message is further generated based on evaluation results obtained from the evaluation.

16. The method of claim 15, further comprising storing, via a database, the evaluation results and one or more of the proximity map, the event, the time, the context-related information, and the environment-related data.

17. The method of claim 11, wherein the message is communicated to the computing device to be presented at the computing device, wherein the message includes one or more of an audio message, a video message, an image message, a olfactory message, and a haptic message.

18. The method of claim 17, wherein a portion of the message is communicated to the computing device, and wherein one or more portions of the message are communicated to the one or more computing devices, wherein the portion and the one or more portions, when presented simultaneously at the computing device and the one or more computing devices, form the message.

19. The method of claim 11, wherein the computing device and the one or more computing devices comprises mobile computers including one or more of smartphones, tablet computers, laptops, head-mounted displays, head-mounted gaming displays, wearable glasses, wearable binoculars, smart jewelry, smartwatches, smartcards, and smart clothing items.

20. The method of claim 11, further comprising facilitating the computing device to receive the message and present the message via one or more input/output components, wherein the participation initiation request is initiated via user-initiated logic and placed via a user interface.

21. At least one machine-readable medium comprising a plurality of instructions, executed on a computing device, to facilitate the computing device to perform one or more operations comprising:
detecting a computing device at a location;
determining proximity of the computing device from one or more computing devices at or around the location, wherein the location relates to an event;
creating a proximity map including plotting of the computing device and the one or more computing devices; and
generating a message for the computing device based on one or more of the proximity map; and
communicating the message to at least one of the computing device and the one or more computing devices, wherein the message is communicated for presentation.

22. The machine-readable medium of claim 21, wherein one or more operations further comprise detecting at least one of the location associated with the computing device and one or more locations associated with the one or more computing devices, wherein the location and the one or more locations are plotted in the proximity map via the proximity detection and mapping logic.

23. The machine-readable medium of claim 21, wherein one or more operations further comprise:
authenticating at least one of the computing device, the one or more computing devices, a user associated with the computing device, and one or more users associated with the one or more computing devices; and
verifying at least one of a participation initiation request from at least one of the user via the computing device and the one or more users via the one or more computing devices.

24. The machine-readable medium of claim 21, wherein one or more operations further comprise determining, via one or more capturing/sensing components, at least one of context-related information and environment-related data relating to at least one of the user, the computing device, the one or more users, and the one or more computing devices.

25. The machine-readable medium of claim 21, wherein one or more operations further comprise evaluating one or more of the proximity map, the event, the context-related information, the environment-related data, and time, wherein the time includes a presentation time of the message, wherein the message is further generated based on evaluation results obtained from the evaluation.

26. The machine-readable medium of claim 25, wherein one or more operations further comprise storing, via a database, the evaluation results and one or more of the proximity map, the event, the time, the context-related information, and the environment-related data.

27. The machine-readable medium of claim 21, wherein the message is communicated to the computing device to be presented at the computing device, wherein the message includes one or more of an audio message, a video message, an image message, a olfactory message, and a haptic message.

28. The machine-readable medium of claim 27, wherein a portion of the message is communicated to the computing device, and wherein one or more portions of the message are communicated to the one or more computing devices, wherein the portion and the one or more portions, when presented simultaneously at the computing device and the one or more computing devices, form the message.

29. The machine-readable medium of claim 21, wherein the computing device and the one or more computing devices comprises mobile computers including one or more of smartphones, tablet computers, laptops, head-mounted displays, head-mounted gaming displays, wearable glasses, wearable binoculars, smart jewelry, smartwatches, smartcards, and smart clothing items.

30. The machine-readable medium of claim 21, wherein one or more operations further comprise facilitating the computing device to receive the message and present the message via one or more input/output components, wherein the participation initiation request is initiated via user-initiated logic and placed via a user interface.
